(19) United States
(12) Patent Application Publication
(10) Pub. No.: US 2013/0003524 A1
(43) Pub. Date: Jan. 3, 2013

(54) Selective Caching in a Packet Network and Packet Loss Repair Using Selective Caching

(76) Inventor: Yangcheng Huang, Athlone (IE)

(21) Appl. No.: 13/521,215

(22) PCT Filed: Jan. 22, 2010
(86) PCT No.: PCT/EP2010/050745

§ 371 Date: Sep. 18, 2012

(51) Int. Cl. H04L 12/56; H04L 29/14; H04L 12/26

(52) U.S. Cl. 370/216; 370/400; 370/252

(57) ABSTRACT

The invention relates to selective caching in a packet network and to packet loss repair in a packet network using selective caching of packets. The invention provides a method of selective caching at an intermediate node in a packet network during a packet transfer session between a sending node and at least one receiving node via the intermediate node in which packet caching is initiated depending on at least one service quality factor related to the packet transfer service provided by a transfer path between the intermediate node and at least one receiving node during the transfer session. The invention also provides a method of packet loss repair using packets cached at an intermediate node.

### TECHNICAL FIELD

The invention relates to selective caching in a packet network and to packet loss repair in a packet network using selective caching of packets.

### BACKGROUND

In a packet transfer session, packets are transferred from a sending node to at least one receiving node in a packet network. During a packet transfer session some packets may be lost. For example, in radio access networks, links of a wireless network typically have lower capacities than those of fixed networks. The available link capacity of a wireless channel is often much less than the channel capacity because of the effects of fading, noise or interference. Packet loss or corruption may occur if the radio link quality is low. Another situation in which packet loss occurs is as a result of poor Digital Subscriber Line (DSL) link quality in the fixed access networks.

Packet losses during a packet transfer session are undesirable. Several techniques, such as forward error correction (FEC), retransmissions, or interleaving, may be used in packet networks to increase packet loss resiliency.

Forward Error Correction (FEC) techniques rely on injecting redundant information into the data stream, which allows the receiver to reconstruct lost data. Some forward error correction (FEC) packets are added at the source or somewhere else in the network such that lost packets can be recovered by means of the FEC packets. However, besides the additional computational complexity, the use of a FEC scheme results in an increased bit rate and increased latency.

Retransmission technique enable the receiver to ask for a retransmission of lost packets from a circular video buffer in an intermediate node that stores the most recent packets or from the content server. The sender may retransmit the packets selectively; i.e., choosing whether to retransmit a requested packet depending on the packet importance, the observed Quality of Service (QoS), and congestion state of the network connection to the receiver.

The use of retransmissions as a repair method for streaming media is appropriate in those scenarios with relaxed delay bounds and where full reliability is not a requirement, since the endpoints may give up retransmitting a lost packet after a given buffering time has elapsed. In situations where full reliability is required or higher delay and jitter can not be tolerated, retransmission is not a feasible solution. Moreover, retransmission-based repair is not appropriate for a multicast session because many retransmission requests for different packets may be generated resulting in a large bandwidth overhead due to control traffic.

Interleaving is a useful technique for reducing the effects of loss, when the size of data units to be transmitted is smaller than the packet size and end-to-end delay is unimportant. Units are re-sequenced before transmission so that originally adjacent units are separated by a guaranteed distance in the transmitted stream and returned to their original order at the receiver. Interleaving disperses the effect of packet losses, but increases latency owing to the time needed for re-sequencing at the sending and at the receiving end.

Packet losses during a packet transfer session between a content sender and one or more receivers may significantly degrade the quality of the received media. When choosing a repair technique for a particular application, the latency that can be tolerated by the application has to be taken into account. In some applications, such as interactive Internet Protocol Television (IPTV) and multimedia conferencing, the end-to-end delay has to be at most a few hundred milliseconds in order to guarantee interactivity.

Packet loss repair latency is a key performance indicator of packet loss repair schemes in packet networks, in particular for streaming applications such as IPTV or multimedia applications. In order to ensure a pleasing user experience, any packet loss should be compensated with low latency.

The present invention seeks to overcome at least some of the disadvantages of the prior art and to provide a method of selective caching at an intermediate node in a packet network, and a method of packet loss repair.

### SUMMARY

According to a first aspect of the invention there is provided a method of selective caching at an intermediate node in a packet network during a packet transfer session between a sending node and at least one receiving node via the intermediate node. In a first step a requirement for packet caching is determined depending on at least one service quality factor related to the packet transfer service provided by a transfer path between the intermediate node and at least one receiving node during the transfer session. In a second step caching of packets of a session at the intermediate node is initiated in response to a determination of a packet caching requirement.

According to a second aspect of the invention there is provided an apparatus for use in a packet network operable to cache packets at an intermediate node selectively during a packet transfer session between a sending node and at least one receiving node via the intermediate node. The apparatus comprises a cache storage. The apparatus also comprises a service quality analyser, for receiving at least one service quality factor related to the packet transfer service provided by a transfer path between the intermediate node and at least one receiving node and for determining a packet caching requirement depending on an analysis of the at least one service quality factor or factors. The apparatus also comprises a selective caching module, for storing packets of a session in the cache storage in response to a determination of a packet caching requirement.

According to a third aspect of the present invention, there is provided a machine-readable medium comprising instructions which cause a processor to perform a method of selective caching at an intermediate node in a packet network during a packet transfer session between a sending node and at least one receiving node via the intermediate node. In a first step of the method a requirement for packet caching is determined depending on at least one service quality factor related to the packet transfer service provided by a transfer path between the intermediate node and at least one receiving node during the transfer session. In a second step of the method caching of packets of a session at the intermediate node is initiated in response to a determination of a packet caching requirement.

A method using the selectively cached packets for packet loss repair is also provided.

The disclosed method of selective caching and the method using the selectively cached packets for packet loss repair provide an effective caching method and packet loss repair.

### BRIEF DESCRIPTION OF THE DRAWINGS

The invention will now be described by way of example with reference to the accompanying drawings:

FIG. 1 is a schematic drawing of network in which embodiments of the invention can be implemented;

FIG. 2 is a schematic drawing of an apparatus according to one embodiment;

FIG. 3 is a flow chart illustrating the steps of a method of one embodiment;

FIG. 3a summarizes the steps of a method of selective caching at an intermediate node according to one embodiment;

FIG. 3b summarizes the steps of a method of selective caching at an intermediate node according to an alternative embodiment;

FIG. 4a shows exemplary signal exchanges for packet loss repair in existing solutions; and

FIG. 4b shows exemplary signal exchanges for packet loss repair in an arrangement using an embodiment shown in FIGS. 2 and 3.

### DETAILED DESCRIPTION

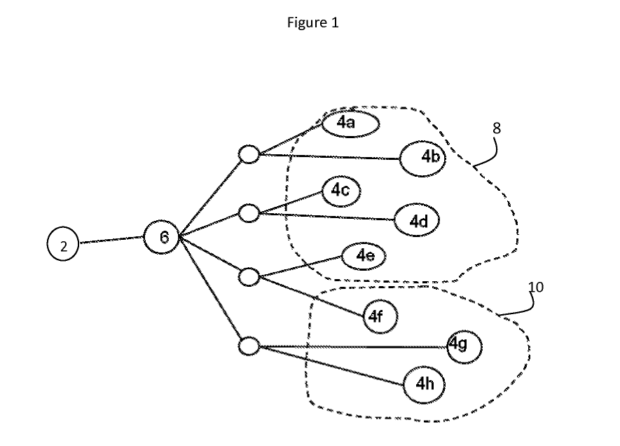

FIG. 1 shows a network supporting a packet transfer session in which packets are transferred from a sending node 2 to a plurality of receiving nodes 4a-4h via intermediate node 6. Receiving nodes 4a-4e are within an area 8 of good reception, while receiving nodes 4f-4h are in an area 10 of poor reception.

In addition to the packets being sent from the sending node to the receiving nodes, the receiving nodes typically also send packets back to the sending node 2. One example of such packets being sent from the receiving node to the sending node is a packet retransmission request, in which a receiving node, having detected a missing packet from an analysis of the received packet numbering, requests a retransmission of the missing packet. Another example of such packets being sent from the receiving node to the sending node is a packet reception report, containing information relating to for example the delay experienced by a packets received at the receiving node.

Such an arrangement is common during multicast packet transfer sessions, for example in IPTV applications. The arrangement is also applicable to radio communication networks as well as to fixed wire networks. Embodiments of the invention can also be used for a point to point (or unicast) packet transfer session where only a single receiving node is present.

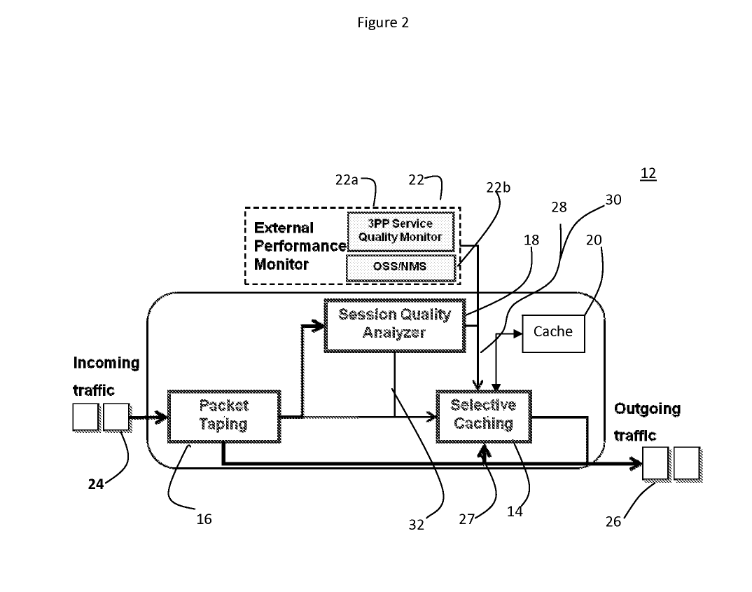

FIG. 2 shows an apparatus 12 for implementing one embodiment of the invention. In the exemplary described embodiment, apparatus 12 is located at an intermediate node 6. In some embodiments of the invention, the intermediate node 6 will be an access node of a packet transport network.

As shown in FIG. 2, in the exemplary embodiment the apparatus 12 comprises: a selective caching module 14; a packet taping module 16; a session quality analyser module 18; and cache storage 20. In addition, an external performance monitor 22 is provided in the exemplary embodiment. It should be noted that in some embodiments the external performance monitor may be omitted.

In the exemplary embodiment, the selective caching module 14, packet taping module 16, session quality analyser module 18 and cache storage 20 of apparatus 12 are arranged on a dedicated service card fitted to the intermediate node 6. This arrangement enables the invention to be applied to existing intermediate nodes, and/or deployed selectively to network areas by adding the service card to the existing intermediate nodes. However, as will be apparent to a skilled person, in another embodiment it would also be possible to incorporate the functions described herein within the intermediate node apparatus itself.

In addition, the cache storage 20 is located in the exemplary embodiment on the apparatus 12 but in some embodiments the cache storage 20 may instead be provided by an intermediate node cache memory (not shown) accessible by the selective caching module 14.

In the exemplary embodiment it is envisaged that the packet taping module 16 is implemented in hardware, and the selective caching module 14 and the session quality analyser 18 are implemented in software. For example, the functions described may be implemented as functional modules of a software program running on a processor. Although the modules are shown separately, the corresponding functions may be distributed between software elements or modules differently from the distribution shown in alternative embodiments, as will be apparent to a skilled person.

Packets passing through the intermediate node 6 within a packet transfer session between a sending node 2 and a receiving node 4a-4h are passed to the apparatus 12 as incoming packet traffic 24, as will be explained in more detail below, and subsequently exit the apparatus 12 as outgoing packet traffic 26 for onward transmission as will be apparent to a skilled person.

It should be noted that the incoming packet traffic 24 and outgoing packet traffic 26 shown in FIG. 2 may be either packets being sent from a sending node 2 to one or more receiving nodes 4a-4h or may be packets being sent from one of the receiving nodes 4a-4h to the sending node 2. During a packet transfer session, the apparatus 12 may selectively cache packets being sent from the sending node to one or more receiving nodes in response to the taping by the packet taping module 16 of packets being sent from one or more of the receiving nodes to the sending node relating to that packet transfer session.

The packet taping module 16 monitors incoming packet traffic 24 for packets of interest, as will be explained later. Typically, as described in the exemplary embodiment of the invention, the packet taping module 16 monitors packet traffic being sent from the receiving nodes 4a-4h to the sending node 2 within a packet transfer session. Incoming traffic packets 24 are monitored by packet taping module 16 as they pass through the intermediate node and leave the intermediate node 6 as outgoing traffic packets 26.

The packet taping module 16 is arranged to extract/filter some specified packets from the incoming packet traffic 24 and is operatively coupled to the session quality analyser 18 and to the selective caching module 14 in order to pass on the extracted packets to the session quality analyser 18 and/or to the selective caching module 14. In some embodiments (not shown) the packet taping module 16 may receive instructions about which packets or flows to be extracted, for example, based on configurations by administrators.

The selective caching module 14 is able to access packet traffic 27 and is operatively coupled to the cache storage 20 to store packets selectively in the cache storage 20, as will be explained in more detail hereafter. Typically, as described in the exemplary embodiment of the invention, the selective caching module 14 selectively caches packet traffic being sent from the sending node 2 to the receiving nodes 4a-4h within a packet transfer session. Incoming traffic packets 24 are accessed by selective caching module 14 as they pass through apparatus 12 and leave apparatus 12 as outgoing traffic packets 26 for onward transmission to the receiving nodes 4a-4h in the packet transfer session.

Typically, this arrangement might be implemented by temporarily storing incoming packets of the incoming packet traffic 24 in a temporary storage (not shown) within the apparatus 12 prior to reading the packets out as the outgoing packet traffic 26. The packet taping module 16 would be arranged to examine the packets stored in the temporary storage to determine the presence of packets of interest. The selective caching module 14 would be arranged to copy a packet selected for caching from the temporary storage to the cache storage 20. However, as will be apparent to a skilled person, the functionality and arrangements described herein may be implemented in a number of different ways in different embodiments of the invention.

The session quality analyser 18 is coupled to receive filtered packets from the packet taping module 16. The session quality analyser 18 is coupled to selective caching module 14 and is arranged to provide start caching instruction 28 and, in some embodiments, stop caching instructions 30 to the selective caching module 14. In addition, the session quality analyser 18 is coupled to the selective caching module 14 to provide a packet transmit request 32 to selective caching module 14.

In the exemplary embodiment shown in FIG. 2, the selective caching module 14 is coupled to cache storage 20 and is able to access the packet traffic passing through apparatus 12 and to store selected packets from the packet traffic in the cache storage 20 in a selective caching mode, as will be explained in more detail hereafter. The selective caching module 14 is also arranged to retransmit packets stored in the cache storage 20 in a packet repair mode, for example by inserting them in the outgoing packet traffic 26, as will be explained in more detail hereafter.

The selective caching module 14 is coupled to the session quality analyser 18 and to the external performance monitor 22, if present, to receive a start caching requirement instruction 28 and, in some embodiments, to receive a stop caching requirement instruction 30. In addition, the selective caching module 14 is also coupled to the session quality analyser 18 to receive a packet transmit instruction 32. Finally, the selective caching module 14 is also coupled to the packet taping module 16 to receive transmit request packets from the monitored packet traffic, as will be explained in more detail below.

An external performance monitor 22 is provided in the exemplary embodiment. The exemplary external performance monitor 22 is provided in the exemplary embodiment with a service quality monitor module 22a and an operations support system (OSS)/network management system (NMS) access module 22b, which both operate to monitor performance of the transfer path between the intermediate node 6 and at least one of the receiving nodes 4a-4h. As will be appreciated by a skilled person, in other embodiments either the service quality monitor module 22a and an OSS/NMS access module 22b may be omitted and either or both the service quality monitor module 22a and an OSS/NMS access module 22b may be replaced with other functions for monitoring the performance of the transfer path. The external performance monitor 22 is coupled to the selective caching module 14 and arranged to provide start caching instruction 28 and, in some embodiments, stop caching instructions 30 to the selective caching module 14.

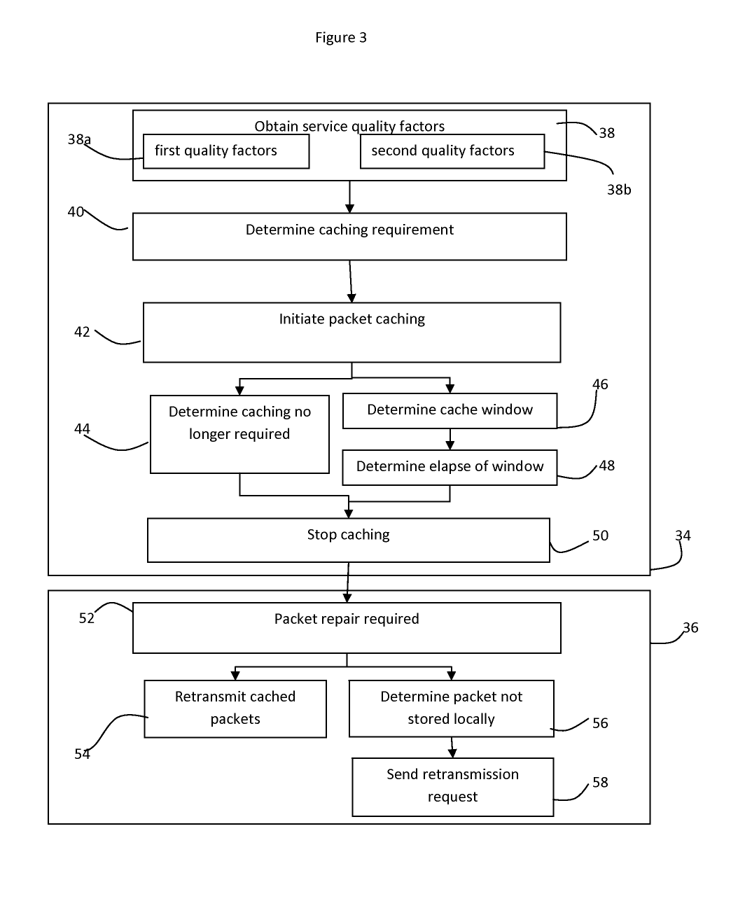

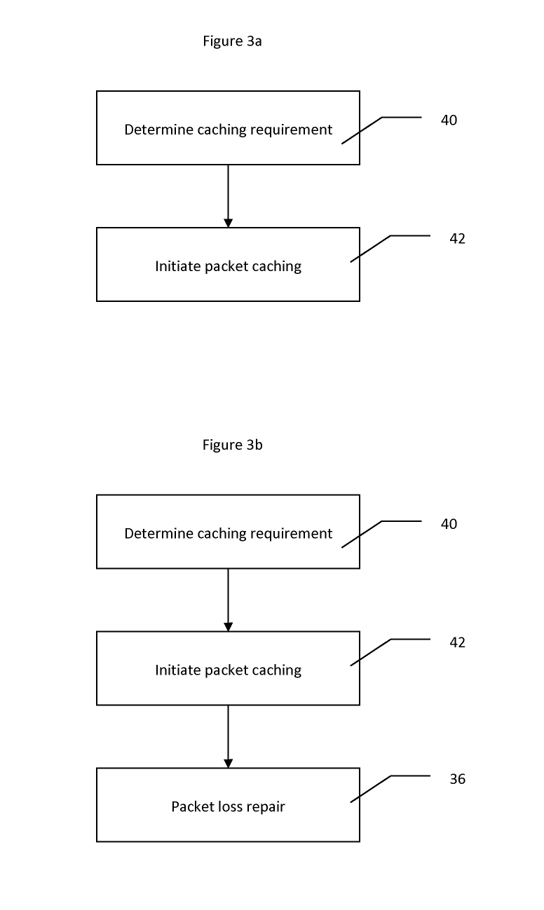

FIG. 3 shows a flow chart of a method of an exemplary embodiment, which can be implemented with the apparatus shown in FIG. 2.

In the exemplary method shown in FIG. 3, a selective caching process 34 and a packet repair process 36 based on the selectively cached packets are described.

Generally in broad outline as will be seen from the following description, the selective caching module 14 in the exemplary embodiment operates selectively to store packets of the packet stream passing through the apparatus 12 in a transfer session in a cache memory 20 when a requirement for caching at the intermediate node 6 is identified based on the packet transfer service provided by a transfer path between the intermediate node 6 and one or more receiving nodes. Furthermore, the selective cache module 14 operates to retransmit the packets stored in cache memory 20 based on the packet transfer service provided by the transfer path between the intermediate node and at least one receiving node, as will be explained in more detail hereafter.

The service quality factors, from which the packet caching requirement is determined, are factors which indicate the quality or reliability or performance of the traffic path between the intermediate node and at least one receiving node. The service quality factors may in some embodiments indicate the occurrence of packet loss between the intermediate node 6 and at least one receiving node. In other embodiments the service quality factors may be used to predict the occurrence of packet loss between the intermediate node 6 and at least one receiving node 4a-4h. In the exemplary embodiment, if packet loss is detected, or can be predicted, based on the service quality factors, a requirement for caching at the intermediate node is established.

In a selective caching process 34 in accordance with the described embodiment, service quality factors are obtained in a first step 38. In the exemplary described embodiment first service quality factors 38a may be obtained by the session quality analyser and/or by the external performance monitor 22, if used, or second service quality factors 38b may be obtained by analysing reception reports from the packet taping module 16. First service quality factors 38a and second quality factors 38b may be used together or separately in an embodiment, as will be understood by a skilled person.

In the exemplary described embodiment first service quality factors 38a relating to the packet transfer service in the transfer path between the intermediate node and at least one receiving node may be obtained by the external performance monitor 22. The external performance monitor 22 monitors burst packet loss in a radio link, for example by Simple Network Management Protocol (SNMP) polling of, or traps from, a third party quality monitor, in some embodiments of the invention. In embodiments of the invention the external performance monitor 22 monitors the quality of a link in the transfer path between an intermediate node and at least one receiving node, for example by using SNMP polling of, or traps from, the link quality monitoring functions of operations support system OSS (such as radio link measurements and Digital Subscriber Line (DSL) link quality measurements).

In the exemplary described embodiment first service quality factors 38a relating to the packet transfer service in the transfer path between the intermediate node and at least one receiving node may be obtained by the session quality analyser 18.

In some embodiments of the invention the session quality analyser 18 may use link quality measurements for a wireless link in a radio access network or a DSL link for a fixed line access network as service quality factors. These link quality measurements can be obtained by the session quality analyser 18 either from an access node of the network, which may be the intermediate node 6, or from the operations support system (OSS) or the network management system (NMS) of the network.

A service quality factor that may be used in embodiments of the invention can be obtained from the receiver reception reports sent from the receiving nodes 4a-4h to the sending node 2, which are taped by the packet taping module 16 and sent to the session quality analyser 18 from the packet taping module 16. One such service quality factor is a measure of service quality or degradation in service quality gathered from feedback reports sent from the receiving node 4a-4h to a sending node 2. In some embodiments of the invention the session quality analyser 18 may use packet delay information and packet delay variation information gathered from feedback reports sent from the receiving node 4a-4h to a sending node 2 as service quality factors.

One service quality factor that may be used in embodiments of the invention is a retransmission request sent from a receiving node 4a-4h to the sending node 2 requesting the retransmission of one or more packets. In the exemplary embodiment the packet taping module 16 recognises the re-transmission requests in the packet traffic and forwards the re-transmission request packets to the selective caching module 14. Since the receipt of a retransmission request indicates that at least one packet that is the subject of the retransmission request has not been received correctly, this service quality factor indicates that packet loss has occurred between the intermediate node and the respective receiving node. Thus in the exemplary embodiment the packet containing the retransmission request is taped by the packet taping module 16, and is forwarded to the selective caching module 14 as a second service quality factor 38b relating to the packet transfer service in the transfer path between the intermediate node and at least one receiving node.

Next, the step of determining a caching requirement 40 using the service quality factors obtained in step 38 is carried out. First service quality factors 38a obtained by the session quality analyser 18 and/or by the external performance monitor 22 are used by the session quality analyser 18 and/or by the external performance monitor 22 in step 40 to determine a caching requirement. If a requirement for caching is determined in step 40, a start caching instruction 28 is sent to the selective caching module 14. Additionally or alternatively, in alternative embodiments second service quality factors 38b obtained by the packet taping module 16 are passed to the selective caching module 14 and used by the selective caching module 14 to determine a caching requirement in determining step 40.

In the exemplary embodiment, a packet caching requirement is determined depending on at least one service quality factor related to the packet transfer service provided by a transfer path between the intermediate node 6 and at least one receiving node 4a-4h during the transfer session. As will be apparent to a skilled person, in the exemplary embodiment, the packet caching requirement may be determined by the session quality analyser 18; the external performance monitor 22; or directly by the selective caching module 14.

In the exemplary embodiment the external performance monitor 22 may determine a requirement for packet caching based on the service quality factors in determining step 40. For example in the exemplary embodiment the external performance monitor determines from the service quality factors whether a degradation of the packet transfer service, such as a service degradation caused by a burst packet loss, has occurred, or whether a future packet loss can be predicted, for example based on a link quality measurements degrading over time, and determines a requirement for caching in determining step 40, based on these determinations. The external performance monitor 22 sends a start caching instruction 28 to the selective caching module 14 if a requirement for caching is established.

In the exemplary embodiment the session quality analyser 18 may determine, in determining step 40, a requirement for packet caching based on the service quality factors. The session quality analyser 18 sends a start caching instruction 28 to the selective caching module 14 if a requirement for caching is established.

In the exemplary embodiment, the session quality analyser 18 determines a requirement for packet caching based on a prediction that packet loss will occur based on link quality measurements determined in step 38 described above. The link quality measurements may relate to wireless links for radio access networks or DSL links for fixed line access networks, as will be apparent to a skilled person. When the link quality is lower than a pre-defined threshold, the packet loss occurrence is predicted and the start-caching request is sent to the selective caching module 14.

In some embodiments, the session quality analyser 18 determines a requirement for packet caching based on a prediction that packet loss will occur based on an analysis of packet delay and variation of the packet delay over time. Methods for packet loss prediction using packet delay information are known, and these methods can be used in the session quality analyser 18 to determine a requirement for selective packet caching at the intermediate node based on packet delay as the service quality factor.

In the exemplary embodiment a simpler approach is proposed which is based on a recognition that an increase of packet delay may indicate that packet loss is likely. The observed inter-packet delay variance increases as the available bandwidth at the links decrease, and vice versa. Therefore, congestion induced packet loss can be predicted by continuously monitoring packet delay and delay variations.

A detailed exemplary algorithm description, PLP_DAN (Packet Loss Prediction Based on Delay Analysis) based on these principles and having a low computational overhead suitable for implementation in a session quality analyser 18 of apparatus 12 at an intermediate node 6 is set out below.

PLP_DAN

| | |
|---|---|
| l_flag = 0; | // Indicator of packet loss |
| for each reception report | // Packet loss prediction based on |
| received | delay in reception reports |

| Process the report and obtain the perceived delay d; | |
|---|---|
| if (d <= d_avg) | // d_avg pre-defined average delay |

| | |
|---|---|
| continue; | // Focus on abnormal delays only |

if (d >= d_prev_)

if ((d − d_prev_) >= (d_prev_ − d_prev2_))

l_flag_++;

else

l_flag_−−;

else

l_flag_−−;

if (l_flag_ > L_THRES_)

| | |
|---|---|
| Send start_caching | // Packet loss expected; send caching |
| request; | request |

l_flag_ = 0;

if (l_flag_ < 0)

l_flag_ = 0;

d_prev2_ = d_prev_{—}
d_prev_ = d

The session quality analyser 18 running the exemplary algorithm in determining step 40 uses delay information from the receiver reception reports and only considers the delays that exceed a pre-defined value (d_avg). The pre-defined value (d_avg) can be selected to be an appropriate value by a skilled person, or may be based on service level agreements (or pre-defined service performance requirements), or may be automatically determined based on delay ranges under good service conditions. The algorithm uses a loss flag value (l_flag) to indicate whether or not packet loss is expected to occur. If the measured delay increases, and the measured inter-packet delay variance increases, packet loss is more likely to occur and the loss flag (l_flag) value is increased. Otherwise, the loss flag (l_flag) value is decreased, which means it is expected that packet loss is less likely to occur. If the loss flag (l_flag) value exceeds a threshold value (L_THRESH), indicating a continuous increase of packet delay, the packet loss is expected. The session quality analyser 18 can therefore determine a packet caching requirement and a start caching requirement instruction 28 is sent to the selective caching module 14.

In the exemplary embodiment of the invention, a packet caching requirement may be determined depending on packet loss or potential packet loss determined in the packet transfer service provided by a transfer path between the intermediate node 6 and a defined percentage, for example 5%, of the receiving nodes 4a-4h during a transfer session. Thus, even if most receiving nodes are receiving acceptable service, selective caching of packets at the intermediate node is initiated when some receiving nodes are not receiving acceptable packet transfer service or are predicted not to receive acceptable packet transfer service.

Clearly in different embodiments of the invention the selective caching may be initiated in response to different percentages of the receiving nodes, as considered appropriate by a skilled person. For example in some embodiments it may be appropriate to initiate selective caching in response to service quality factors relating to a single receiving node, whereas in other embodiments it may be appropriate to initiate selective caching in response to the service quality factors connected with a much higher percentage of receiving nodes.

As will be appreciated by a skilled person, the functions of the session quality analyser 18 and the external performance monitor 22 are very similar and therefore in some embodiments these functions may be combined.

A requirement for caching is established by the selective caching module 14, determining step 40, in response to the receipt by the selective caching module 14 of retransmission requests as the service quality factors from the packet taping module 16, as described above. In this case, an actual packet loss has occurred and therefore a requirement for selective caching at the intermediate node by the selective caching module 14 is established.

In response to the receipt of a start caching instruction 28, or in response to the determination of a caching requirement in determining step 40, the selective caching module 14 initiates packet caching in step 42.

In the exemplary embodiment, once the selective caching module 14 has initiated selective caching in step 42, packets are cached by the selective caching module 14 in the cache storage 20 until either a determination is made that caching is no longer required, step 44, or until the elapse of a caching window period is determined, steps 46, 48. However, the described methods and many other methods for determining cessation of caching may be used alone or in combination as appropriate in different embodiments as will be apparent to a skilled person.

In the exemplary embodiment in step 44, the external performance monitor 22, the session quality analyser 18 and the selective caching module 14 continue to monitor the service quality factors in a similar manner to that described above with reference to step 40. When the service quality factors indicate that packet transfer paths are able to, or are likely to be able to provide a reliable packet transfer without packet loss between the intermediate node 6 and the receiving nodes 4a-4h, a determination is made to stop caching, step 44. As previously discussed with reference to the determination to initiate caching in step 40, in embodiments of the invention this determination may be made on the basis of service quality factors relating to the transfer path for one, some or all of the receiving nodes 4a-4h. In the exemplary embodiment the external performance monitor 22 and the session quality monitor 18 send a stop caching instruction 30 to the selective caching module 14 in response to a determination to stop caching.

In step 46 the selective caching module determines the duration of the caching window within which the packets are to be cached.

An exemplary pseudo-code algorithm for determining caching window duration is set out below. However, it will be clear to a skilled person that other methods of determining the caching window duration are possible in different embodiments.

AutoSizingCachWnd

| | |
|---|---|
| l_d = 0; | // l_d; packet loss duration |
| c_wnd = cwnd_0; | // c_wnd; caching window; cwnd_0; pre-defined value; |
| for each reception report received | // Packet loss in reception reports |

| Process the report and obtain the packet loss ratio l; | |
|---|---|
| if (l <= l_thres) | // l_thres; pre-defined packet loss threshold |

| | |
|---|---|
| if (l_d > 0) | // Packet loss duration is being calculated |

| | |
|---|---|
| if (cur_t > t_timeOut) | // Packet loss ends; packet loss duration is being calculated |

| | |
|---|---|
| l_d = l_d + rr_interVal; | // rr_interVal; reception reporting interval |
| c_wnd = (1/16.) * (l_d − c_wnd); | // Calculate each Wnd using moving average alg. |

l_d = 0;

| | |
|---|---|
| continue; | // Jump over satisfactory packet loss |

| | |
|---|---|
| if (l_d > 0) | // Packet loss duration is being calculated |

l_d = l_d + rr_interVal;

else

| | |
|---|---|
| l_d = rr_interval; | // Start calculating a new packet loss duration |
| t_timeOut = cur_t + LOSS_TIMEOUT | // Set the timeout time of the packet loss |

In the exemplary pseudo-code algorithm AutoSizingCachWind the caching window duration is determined and kept updated based on the expected duration of packet loss (l_d) derived from the reception reports sent from receiving nodes and taped by the packet taping module 16 and forwarded to the selective caching module 14.

It is considered that no packet loss is detected, if the packet loss ratio (l) is below a pre-defined threshold value (l_thres). The threshold value (l_thres) can be selected to be an appropriate value by a skilled person, or based on service level agreements (or pre-defined service performance requirements), or automated determined based on packet loss ratio ranges under good service conditions. When the packet loss is not continuously detected within a predetermined timeout period (LOSS_TIMEOUT), the packet loss is considered to end and the packet loss duration is calculated. In the exemplary embodiment the size of the caching window is determined and kept updated based on the calculated packet loss duration, for example by applying a moving average algorithm.

Other methods of determining a caching window size can be used in other embodiments.

In step 48 the elapse of the caching window is determined.

At the end of the caching period, the selective caching module 14 stops caching packets from the passing packet traffic in step 50.

FIG. 3a summarizes the steps of a method of selective caching at an intermediate node, comprising a first step 40 of determining a caching requirement; and a second step 42 of initiating packet caching.

Thus a method and apparatus for selectively caching packets at an intermediate node on the basis of service quality factors is provided.

A method for packet loss repair 36 using packets cached at an intermediate node of a packet transfer session will now be described. Although FIG. 3 shows the method 36 for packet loss repair being initiated after completion of the method of selectively caching 34, it will be apparent that it is not necessary for the selective caching of packets at the intermediate node to be completed prior to the initiation of the packet repair method.

In the method of packet repair 36 it is first determined whether packet repair is required in step 52. In the exemplary described embodiment the packet repair requirement may be determined in the session quality analyser 18. If a requirement for packet repair is determined in the session quality analyser 18, a packet transmit request 32 is sent to selective caching module 14. Alternatively the packet repair requirement may be determined directly by the selective caching module 14 in step 52.

In response the receipt of the packet transmit request 32 from the session quality analyser, or in response to the determination that packet repair is required, the selective caching module 14 retrieves the packets for retransmission from the cache storage 20 and retransmits the cached packets, step 54.

Alternatively, if the required packet is not stored locally, step 56, the selective caching module sends a retransmission request, in step 58, to another node in which that packet has been cached. There are many methods of handling retransmission requests, as will be apparent to a skilled person, and these methods will not therefore be explained in more detail.

Retransmitted packets requested by the receiving nodes 4a-4h may be delivered from the cache 20 at the intermediate node 6 over the transfer path to the receiving bodes 4a-4h either via unicast (using a point to point (ptp) channel), multicast (using a point to many (ptm) channel), or a mix of both, as seems appropriate to a skilled person.

In the exemplary embodiment, the choice between a ptp channel and a ptm channel for re-transmission of packets is based on the number of requests received. If there are a small number of retransmission requests, for example fewer than 5 retransmission requests, received for the same session, the retransmission might typically be sent to the receiving nodes via unicast (i.e. a ptp channel). With an increase in retransmission requests, an existing ptm channel may be used or a new ptm channel may be set up to send the requested packets, since the overhead to set up individual ptp channels would be significant.

Where the existing ptm channel is used to retransmit packets, all nodes and user equipment at receiving nodes associated with the existing ptm channel receive the retransmitted packets, including those that received the packets originally. However, user equipment that received the original packet without loss will recognise the retransmitted packet as a duplicated packet, based on the packet sequence numbers, and will merely discard the duplicate packet.

Further details of resource allocation for the packet retransmission are not relevant, and will not be discussed further.

The proposed method of packet loss repair could be deployed with ease into existing access nodes as an additional feature. It is not necessary for user equipment at the receiving nodes 4a-4h to be aware of the location of the cache since in the exemplary embodiment an access node in which the method is implemented intercepts the retransmission request sent from the receiving node to the sending node 2 and simply retransmits the packets from the cache at the intermediate node. Thus implementation of the exemplary embodiment of the invention leads to reduced retransmission latency and a reduction of both bandwidth used and content server processing overhead.

FIG. 3b summarizes the steps of a method comprising a first step 40 of determining a caching requirement; and a second step 42 of initiating packet caching; and a third step of packet loss repair 36.

Thus a method and apparatus for packet loss repair using selective caching have been provided.

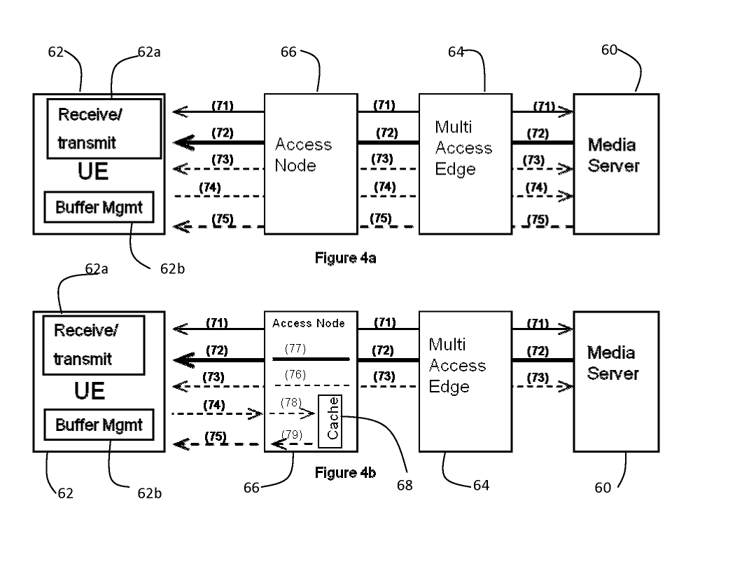

The use of the apparatus and method as described above will now be described with reference to FIGS. 4a and 4b.

FIG. 4a shows a packet loss repair arrangement in an existing packet retransmission scheme, showing the signaling during packet transfer session set up and packet loss repair in an exemplary network.

In the exemplary arrangement shown in FIG. 4a a packet transfer session is to be set up between the media server 60 and the user equipment (UE) 62 via, inter alia, a multi-access edge node 64 and an access node 66. The UE 62 has receive/transmit logic 62a and buffer management module 62b for use during a packet transfer session as will be apparent to a skilled person. In this exemplary arrangement the media server 60 in FIG. 4a corresponds with the sending node 2 in FIG. 1; the access node 66 corresponds with the intermediate node 6 in FIG. 1 and the UE 62 corresponds with one of the receiving nodes 4a-4h.

The UE 62 may communicate with the access node 66 using a number of different technologies, including a radio access network. In the exemplary arrangement, the UE is a set top box (STB) in an Internet Protocol Television (IPTV) system.

Packets 71-75 are exchanged between the media server 60 and the UE 62 during set up of the packet transfer session and a packet loss repair in the exemplary arrangement, as follows:

71: RTSP Setup/Response Packets;

72: RTP Packets RFC3550—original data packets;

73: RTCP Reporting RFC3550—reception quality report;

74: RTCP NACK RFC 4585—retransmission request;

75: RXMIT Packets RFC 4588—retransmitted packets requested by the UE62.

FIG. 4b shows an arrangement in which the exemplary embodiment described above with reference to FIGS. 2 and 3 is implemented in access node 66. Elements and packets that are the same as elements and packets in FIG. 4a have been given the same reference numerals.

The access node 66 also has a cache 68 therein, corresponding to the cache storage 20 shown in FIG. 2.

Thus in the exemplary packet retransmission scheme, retransmission requests 74 are intercepted in the access node 66 in accordance with the exemplary embodiment described above with reference to FIGS. 2 and 3, and packets are retransmitted from the cache 68 of the access node 66 directly.

The new packet and actions in the exemplary arrangement are:
76: packet loss detection or prediction based on delay variation (delay calculated based on RTCP reports—RFC 3550)
77: selective caching of RTP Packets RFC3550—original data packets in response to packet loss detection or prediction 76
78: interception of 74: RTCP NACK RFC 4585—retransmission request at access node 66
79: fast packet retransmission from cache 68.

For the end users UE 62, the caching-retransmission process running inside the access node 66 is totally transparent, since packet transfers 71-75 are kept the same in both schemes. The UE 62 still sends retransmission requests to the media server 60. However, the requests are intercepted in the access node 66 if the requested packets have already been cached, and the packets are then retransmitted from the cache 68 immediately (76-79). Thus embodiments of the invention may provide low latency in packet loss repair.

Thus a method of packet repair loss based on service quality factors using selectively cached packets is provided.

Modifications and other embodiments of the disclosed invention will come to mind to one skilled in the art having the benefit of the teachings presented in the foregoing description and the associated drawings. Therefore it is to be understood that the invention is not to be limited to specific embodiments disclosed and that modifications and other embodiments are intended to be included within the scope of this disclosure. Although specific terms may be employed herein, they are used in a generic and descriptive sense only and not for the purposes of limitation.

1. A method of selective caching at an intermediate node in a packet network during a packet transfer session between a sending node and at least one receiving node via the intermediate node, the method comprising the steps of:
determining a requirement for packet caching depending on at least one service quality factor related to the packet transfer service provided by a transfer path between the intermediate node and at least one receiving node during the transfer session; and
initiating caching of packets of a session at the intermediate node in response to a determination of a packet caching requirement.

2. The method as claimed in claim 1 where the packet caching requirement is determined when the at least one service quality factor indicates packet loss between the intermediate node and at least one receiving node.

3. The method as claimed in claim 1 where the packet caching requirement is determined when the at least one service quality factor predicts packet loss between the intermediate node and at least one receiving node.

4. The method as claimed in claim 1 where at least one service quality factor relates to or is derived from link quality measurements of at least one link in the transfer path.

5. The method as claimed in claim 1 where at least one service quality factor relates to or is derived from measurements of packet delay for the transfer path between the intermediate node and a receiving node.

6. The method as claimed in claim 5 further comprising the step of determining a service quality factor from changes in successive packet delay measurements in respect of the transfer path between the intermediate node and a receiving node.

7. The method as claimed in claim 1 where at least one service quality factor is derived by the intermediate node from messages sent from a receiving node to the sending node.

8. The method as claimed in claim 1 where at least one service quality factor relates to or is derived from a retransmission request sent from one or more receiving nodes.

9. The method as claimed in claim 1 where at least one service quality factor relates to or is derived from a reception feedback report from one or more receiving nodes.

10. The method as claimed in claim 1 in which during a packet transfer session between a sending node and a plurality of receiving nodes via the intermediate node a requirement for packet caching is determined in response to the service quality factors relating to the packet transfer service provided by transfer paths from the sending node to a proportion of the plurality of receiving nodes.

11. The method as claimed in claim 1 further comprising the steps of:
determining from at least one service quality factor related to the packet transfer service provided by a transfer path between the intermediate node and at least one receiving node that packet caching is no longer required; and
stopping caching of packets of a session at the intermediate node in response to a determination that packet caching is no longer required.

12. The method as claimed in claim 1 further comprising the step of:
after caching has been initiated, stopping the caching of packets after the elapse of a caching window.

13. The method as claimed in claim 12 further comprising the step of:
determining the duration of the caching window depending at least in part on the duration of a period of packet loss.

14. The method as claimed in claim 1 further comprising packet loss repair comprising the steps of:
determining that packet repair is required based on the packet transfer service provided by the transfer path; and
retransmitting cached packets in response to a determination that packet repair is required.

15. The method as claimed in claim 14, in which at least one service quality factor relates to or is derived from link quality measurements of at least one link in the transfer path and in which at least one service quality factor is used in the step of determining that packet repair is required.

16. The method as claimed in claim 14, in which the cached packets are retransmitted during the existing packet transfer session.

17-18. (canceled)

19. Apparatus for use in a packet network operable to cache packets at an intermediate node selectively during a packet transfer session between a sending node and at least one receiving node via the intermediate node, the apparatus comprising:
a cache storage;
a service quality analyser, for receiving at least one service quality factor related to the packet transfer service provided by a transfer path between the intermediate node and at least one receiving node and for determining a packet caching requirement depending on an analysis of the at least one service quality factor or factors; and
a selective caching module, for storing packets of a session in the cache storage in response to a determination of a packet caching requirement.

20. The apparatus as claimed in claim 19, further comprising:
a packet taping module, arranged to monitor a stream of packets sent between the sending node and at least one receiving node during a packet transfer session, the packet taping module being operable to extract from the stream a packet containing service quality factor information and to forward extracted packets to the analyser.

21. The apparatus as claimed in claim 19, comprising:
a link quality analyser for determining a packet caching requirement based on link quality measurements of at least one link of the transfer path between the intermediate node and at least one receiving node.

22. A non-transitory machine-readable medium comprising instructions which cause a processor to perform a method of selective caching at an intermediate node in a packet network during a packet transfer session between a sending node and at least one receiving node via the intermediate node, the method comprising the steps of:
determining a requirement for packet caching depending on at least one service quality factor related to the packet transfer service provided by a transfer path between the intermediate node and at least one receiving node during the transfer session; and
initiating caching of packets of a session at the intermediate node in response to a determination of a packet caching requirement.

23. (canceled)
